(19) United States
(12) Patent Application Publication
(10) Pub. No.: US 2025/0356221 A1
(43) Pub. Date: Nov. 20, 2025

(54) METHOD, APPARATUS, AND COMPUTER-READABLE MEDIUM FOR GENERATING A HYPOTHESIS FROM A KNOWLEDGE GRAPH

(71) Applicant: Sony Group Corporation, Tokyo (JP)

(72) Inventors: Tarek Richard BESOLD, Tokyo (JP); Uchenna AKUJUOBI, Tokyo (JP); Samy BADREDDINE, Tokyo (JP); Jihun CHOI, Tokyo (JP); Kana NISHIKAWA, Tokyo (JP); Christoph WEHNER, Tokyo (JP); Priyadarshini KUMARI, Tokyo (JP); Hsing-Chi HWANG, Tokyo (JP); Hatem Mohamed Abdelfattah Eid ELSHAZLY, Tokyo (JP); Chrysovalanto Theodora ILIOPOULOU, Tokyo (JP); Pablo SANCHEZ, Tokyo (JP)

(73) Assignee: Sony Group Corporation, Tokyo (JP)

(21) Appl. No.: 18/664,454

(22) Filed: May 15, 2024

(51) Int. Cl. G06N 5/022

(52) U.S. Cl. CPC G06N 5/022

(57) ABSTRACT

A method, apparatus, and non-transitory computer-readable medium for generating a hypothesis from a knowledge graph. The method comprises processing the knowledge graph comprising a plurality of fact triples. Each fact triple of the plurality of fact triples comprises two concepts of a set of concepts and one relationship of a set of relationships. Each fact triple is also associated with at least one source. The method further comprises generating the hypothesis from data representing multiple triples, the hypothesis. The hypothesis includes at least one predicted triple having a concept-concept relationship not found in the knowledge graph. The method then outputs at least one source and/or explanation data for the hypothesis.

### BACKGROUND

Science is advancing at an increasingly quick pace, as evidenced, for instance, by the exponential growth in the number of published research articles per year. Effectively navigating this ever-growing body of knowledge is tedious and time-consuming in the best of cases, and more often than not becomes infeasible for individual scientists. In order to augment the efforts of human scientists in the research process, computational approaches have been introduced to automatically extract hypotheses from the knowledge contained in published resources. These approaches demonstrate the usefulness of computational methods in extracting latent information from the vast body of scientific publications. One approach for hypothesis generation is the ABC model. In essence, if entities A and B, as well as entities A and C, share connections, then entities B and C should be associated. Knowledge graphs (KG) can be used to structure this scientific information by showing entities (A, B, and C) and their interrelationships. Based on structural balance theory, computational methods may be used to identify potential associations between entities (B and C) if they both share a connection with a common entity (A), thus enabling the prediction of new, meaningful connections that can form the basis of hypotheses.

KGs, despite their vast potential for structuring and leveraging information, are notoriously incomplete. To mitigate this issue, link prediction has emerged as a technique for uncovering previously unknown links within these graphs. Knowledge graph embedding (KGE) models have become the de facto standard because they capture the complex relationships and semantics embedded within the graph structure through high-dimensional latent representations. However, despite their effectiveness, these models are criticized for their “black box” nature, which obscures the underlying mechanisms and rationales behind their predictions, posing challenges for explainability in critical applications. Some methods for explaining black box models have made progress in demystifying the opaque decision-making processes of complex models. However, applying these methods to KGE models presents a non-trivial challenge, and these methods traditionally work by attributing parts of the input as relevant to the model's output.

Embedding-based link prediction operates differently. It relies on the latent representations of entities and relations in a triple (head, relation, tail) to compute a score with the help of an interaction function. This score is then used to create an ordinal ranking of the plausibility of different permutations for the head, relation, or tail. In this context, simply assigning relevance to the latent representations of the triple provides minimal insight into the underlying rationale of the prediction. The inherent complexity of these embeddings and the abstract nature of the relations they capture make it difficult to draw clear, interpretable connections between input features and the model's output. Therefore, there may be a need for improvement in explaining KGE models.

### SUMMARY

The appended claims address this need. KGE models are essential to knowledge graph completion yet criticized for their opaque, black-box nature. Despite their significant success in capturing the semantics of KGs through high-dimensional latent representations, their inherent complexity poses substantial challenges to explainability. The embodiments proposed herein directly decode the latent representations encoded by KGE models, leveraging the principle that similar embed-dings reflect similar behaviors within the KG. By identifying distinct structures within the subgraph neighborhoods of similarly embedded entities, the disclosure identifies the statistical regularities on which the models rely and translates these insights into human-understandable symbolic rules and facts. This bridges the gap between the abstract representations of KGE models and their predictive outputs, offering clear, interpretable insights. Key contributions include a novel post-hoc explainable artificial intelligence (AI) method for KGE models that provides immediate, faithful explanations without retraining, facilitating real-time application even on large-scale knowledge graphs. The method's flexibility may enable the generation of rule-based, instance-based, and analogy-based explanations, meeting diverse user needs. The disclosed embodiments deliver faithful and well-localized explanations, enhancing the transparency and trustworthiness of KGE models.

According to the first aspect, the present disclosure provides a method for generating a hypothesis from a knowledge graph. The method comprises processing the knowledge graph, which includes a plurality of fact triples, each comprising two concepts and one relationship, all associated with at least one source. Based on user input data, the method generates a hypothesis from data representing multiple triples, including at least one predicted triple having a concept-concept relationship not found in the knowledge graph. The method further involves outputting at least one source and/or explanation data for the hypothesis.

According to a further aspect, the present disclosure provides a non-transitory, computer-readable medium. The medium comprises program code that, when executed on a processor, causes the processor to generate a hypothesis from a knowledge graph as described above.

According to another aspect, the present disclosure provides an apparatus for generating a hypothesis. The apparatus comprises control circuitry configured to process a knowledge graph containing a plurality of fact triples, each triple comprising two concepts and one relationship, all associated with at least one source. The apparatus generates a hypothesis based on user input data, where the hypothesis includes at least one predicted triple having a concept-concept relationship not found in the knowledge graph. The apparatus outputs at least one source and/or explanation data for the hypothesis.

### BRIEF DESCRIPTION OF THE FIGURES

Some examples of apparatuses and/or methods will be described in the following by way of example only and with reference to the accompanying figures, in which

FIG. 1 shows a flowchart of a method for generating a hypothesis from a knowledge graph;

FIGS. 2A and 2B show example knowledge graphs with predicted triples;

FIGS. 3A and 3B show approaches for building a knowledge graph;

FIG. 4 shows a block diagram of an example of an apparatus or device for generating a hypothesis comprising control circuitry; and

FIG. 5 shows a block diagram of a system for generating a hypothesis; and

FIG. 6 shows a block diagram 600 with an end-user terminal for obtaining a hypothesis.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

Unless otherwise defined, all terms (including technical and scientific terms) are used herein in their ordinary meaning of the art to which the examples belong.

Specific details are set forth in the following description, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply that the described element item must be in a given sequence, either temporally or spatially, in ranking, or in any other manner. “Connected” may indicate elements are in direct physical or electrical contact with each other, and “coupled” may indicate elements cooperate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

It should be noted that the example schemes disclosed herein are applicable for/with any operating system and a reference to a specific operating system in this disclosure is merely an example, not a limitation.

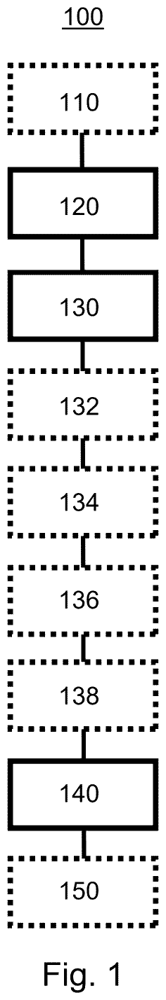

FIG. 1 shows a flowchart of method 100 for generating a hypothesis from a knowledge graph (KG). Method 100 includes processing 120 of the knowledge graph, which comprises a plurality of fact triples. Each fact triple of the plurality of fact triples comprises two concepts (a head and a tail concept) of a set of concepts and one relationship of a set of relationships (e.g., a concept-concept relationship triple). Each fact triple may also be associated with at least one source. Method 100 further comprises generating hypothesis 130 from data representing multiple triples, the hypothesis including at least one predicted triple having a concept-concept relationship not found in the knowledge graph. The method then outputs 140 of at least one source and/or explanation data for the hypothesis.

Scientists are creative, and they undertake certain creative activities, namely, producing new scientific hypotheses and validating them creatively. One way to support scientists in finding new hypotheses is to search for KGs that are factually supported and suggest new connections for them to explore. A hypothesis may simply be a predicted link in a knowledge graph. In particular, each predicted link in the knowledge graph, together with the two end nodes, may be taken to be a hypothesis. Finding a link between two concepts, even when the relationship is unknown or unclear, may help researchers and scientists to develop more concrete hypothesis for laboratory testing.

A KG is a directed labeled graph G, consisting of triples (i.e., facts) G⊆E×R×E from the entity set E (e.g., concepts) and relation set R, allowing the traversal of a triple (e^{head}, r, e^{tail}) from a head to a tail entity. This may also be known as a concept-concept-relationship (e.g. an entity-entity-relationship) triple, which relates a first concept to a second concept. Triples can be expressed as grounded binary predicates r(e^{head}, e^{tail}). The relation acts as the binary predicate and the entities as the grounding constants. A KG assigns each entity and relation a symbolic label (e.g., name). KGs are structured according to a semantic schema s: E→C. This schema categorizes entities into classes C within the KG's domain, facilitating storing and retrieving semantically rich, relational data. Nonetheless, the construction of KGs demands substantial expert knowledge, leading to the common issue of incomplete knowledge graphs. Moreover, even experts might not yet have the relevant knowledge as it simply has not yet been discovered. Hypothesis-generation as presently disclosed may target new hypothesis (i.e., insights which are not known to experts), in particular. A predicted triple for the KG may comprise a first concept and a second concept of the set of concepts E and a predicted relationship of the set of relationships R.

KGs can represent two concepts or entities with multiple links or relationships between them, capturing the complexity and richness of real-world interactions. For instance, in a biomedical KG, the concepts “gene” and “disease” might be connected through various relationships such as “causes,” “is associated with,” “is a risk factor for,” etc. This multi-relational structure allows KGs to encapsulate different dimensions of knowledge, offering a more nuanced understanding of how concepts interact. By modeling these diverse relationships, KGs enable more sophisticated queries and inferences, facilitating deeper insights and more accurate hypothesis generation across domains.

Method 100 may further comprise receiving user input data, wherein the user input selects at least one of the first concept, the second concept, or the predicted relationship. The method may be performed based solely on the KG; however, incorporating user input may allow user to guide the hypothesis generation process by specifying particular elements of interest. For example, a researcher might input a specific gene (first concept) and a disease (second concept) they are investigating, or they might select a type of interaction (predicted relationship) such as “inhibits” or “associates with.” By incorporating these user-specified parameters, the system can tailor its search and analysis within the knowledge graph to predict triples and generate more relevant and targeted hypotheses, enhancing the efficiency and effectiveness of the research process. Additionally, user input may be used after hypothesis generation to select hypotheses of interest from the overall set of generated hypotheses (i.e., querying).

KG completion addresses the challenge of inherently incomplete KGs. For KGs, there exists a subset of correct but unknown triples G_{unknown}⊆E×R×E that do not intersect with the existing graph G. KGC aims to uncover these missing facts by exploiting the regularities and patterns inherent in the KG, thus deducing the unknown triples. In practice, KGC models are queried with partial triples (e^{head}, r,?), (?, r, e^{tail}), or (e^{head},?, e ^{tail}), seeking to complete these by predicting the missing entity or relation. The model then generates a ranked list of candidates. The higher the rank, the more plausible a candidate may complete the triple.

KGE models enable KGC by focusing on learning latent space representations (i.e., embeddings) for entities and relations within a KG. By employing interaction functions, these models assign scores to the embeddings of triples, where higher scores indicate a greater plausibility of the triple being true. This scoring mechanism is crucial for optimizing the embeddings to favor existing triples over corrupted ones, ensuring that the embeddings reflect the KG's statistical regularities. Consequently, entities exhibiting similar behaviors within the graph are represented by similar embedding. Some models optimize embeddings by aligning the sum of entity and relation embeddings with the missing entity's embedding. Other models have refined this approach by implementing a trilinear dot product and extending capabilities to capture non-symmetric relationships. Still, other models utilize convolutions in the interaction function. Despite the advancements in KGE models, the complexity and abstractness of the embeddings pose significant challenges in establishing clear, interpretable links between input features and model outputs.

The knowledge graph may comprise a plurality of nodes connected by a plurality of edges, wherein each node represents one concept of the set of concepts, and each edge is classifiable as one relationship of the set of relationships.

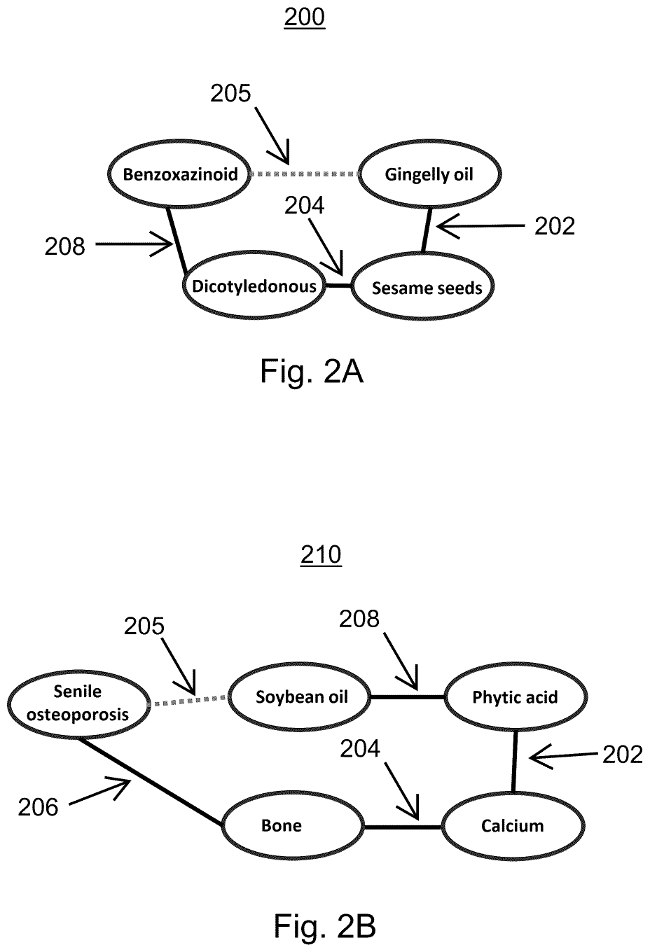

FIGS. 2A and 2B show example knowledge graphs with predicted triples. FIG. 2A shows a KG 200 with three fact triples connected by the three relationships 202, 204, 206 and a predicted relationship 205. FIG. 2B shows a KG 210 with four fact triples connected by the four relationships 212, 214, 216, 218 and a predicted relationship 215. When forming a hypothesis, a scientist may think that chemical A could be a catalyst for chemical B, that a gene is causal for a disease, or that a pharmaceutical molecule could be an antagonist to this metabolic process. Predicted triples likewise seek to create links in a KG between two elements or concepts and determine what relationship the link has. This approach aims to find, for instance, chemicals that are also likely catalysts of each other but not written about. Whenever two concepts in the KG are not connected, they either do not have anything to do with each other, or there is a connection that has not yet been discovered.

The present disclosure leverages the principle that KGE models encode a KG's statistical regularities into latent representations, reflecting the KG's structure and interactions. Central to the disclosure is the notion that entities with similar embeddings behave similarly within the KG. These embeddings may be decoded by identifying distinct structures in the KG, particularly in the subgraph neighborhoods of entities with similar embeddings, revealing the model's relied-upon statistical regularities. These structures can be represented as human-understandable symbolic rules and facts, clarifying the predictive patterns in localized subgraphs. The present disclosure may outperform state-of-the-art methods regarding faithfulness to the model's decision process, and the explainable evidence is better centered around a region of interest. This, firstly, contributes a novel post-hoc explainable AI method for KGEs. In contrast to others, the disclosure is aligned with the operational mechanics of KGE models, ensuring explanations are faithful to the model's decision-making process, localized around a region of interest, and immediate, thereby eliminating the need to retrain the model on occluded training data. This may enable real-time, scalable explanations within extensive KGs. Secondly, the present disclosure is versatile, producing explanations in various forms, including rule-based, instance-based, and analogy-based, making it adaptable to diverse user requirements. Thirdly, the present disclosure may perform well compared to existing state-of-the-art methods regarding faithfulness to the model's decision-making process and providing more relevant explanations centered on the user's region of interest.

According to a further aspect of method 100, generating hypothesis 130 may further comprise determining a sub-graph neighborhood 132 of the knowledge graph for at least one predicted triple, then creating a plurality of positive concept pairs and a plurality of negative concept pairs. Each positive concept pair may represent one fact triple in the sub-graph neighborhood comprising the predicted relationship. Each negative concept pair may present one triple comprising the predicted relationship not found within the knowledge graph. Method 100 further comprises extracting a plurality of clauses 134 from a combined set of the plurality of positive concept pairs and the plurality of negative concept pairs. Then, the method comprises determining the relevance 136 of each clause of the plurality of clauses and selecting hypothesis 138 from the plurality of clauses based on the relevance of each clause.

Relevance may be quantified as a score or percentage for each clause or predicted link, indicating the strength or likelihood of the connection. Multiple different relationships can be predicted between two concepts, reflecting the multifaceted nature of their interactions. For example, between the concepts “gene” and “disease,” the system might predict relationships with different relevance such as “causes,” “is associated with,” and “is a risk factor for,” each with its own relevance score. This approach allows for a detailed and graded understanding of how concepts are related, supporting more precise and informative hypothesis generation.

The approach is rooted in the understanding that KGE models encapsulate the intrinsic statistical patterns of a KG in their latent representations, encoding the graph's topology and the interactions between its entities. At the core is the assumption that entities sharing similar embeddings exhibit comparable behavior within the KG. By analyzing the subgraph neighborhoods of these entities, statistical regularities are discovered, in the form of conjunctive clauses (e.g., r₁(x, Y)∧r₂ (Y, z)), that KGE models depend on. These regularities are then translated into symbolic rules, or triples understandable to humans, thereby uncovering the rationale behind the models' predictions in specific subgraph contexts. This allows post hoc explanation of the predicted triple (eₚ^{head}, rₚ, eₚ^{tail}) by accessing the knowledge graph and the embeddings learned by the KGE.

According to a further aspect of method 100, outputting 140 explanation data for the hypothesis may further comprise identifying fact tuples from the knowledge graph that justify at least one predicted triple. This may involve displaying detailed explanations that trace back to specific fact tuples, providing users with comprehensive insights into the rationale behind each hypothesis.

Moreover, the UI may include interactive elements such as visualizations of the knowledge graph, highlighting the connections between concepts and relationships that form the basis of the hypothesis. Users may click on nodes representing concepts or edges representing relationships to view detailed explanations and source links. This interactive and queryable UI ensures that users can not only see the explanations but also actively engage with the data, fostering a deeper understanding and facilitating further research.

By allowing researchers to query sources directly through the UI, the system may enhance the transparency and robustness of hypothesis validation, ultimately contributing to more rigorous and reliable scientific inquiry.

The present disclosure may be built on five steps: First, getting k-nearest neighbors in the latent space of the predicted triple. Second, positive and negative entity pairs from the nearest neighbors should be created. Third, mine all possible clauses and their frequency within the subgraph-neighborhood of the pairs. Fourth, identify the most descriptive clauses for positive entity-pairs with the help of a surrogate model. Fifth, create an explanation from the n-most descriptive clauses. The following section shall introduce the step-by-step post-hoc explainability method.

In the first step, embedding a given predicted triple is designated as tₚ. The k-nearest neighbors t₁, t₂, . . . , tₓ are then retrieved from the set of all training pair embeddings Tₜrain, based on the Euclidean distance (L² norm). The equation describes the retrieval:

$$kNN ( {t}_{p} ) = {arg min}_{t ∈ T} {}_{k} {‖ {t}_{p} - t ‖}_{2}$$

In this equation, argminₖ identifies the k embeddings t that yield the smallest Euclidean distances to tₚ, thus isolating the embeddings in the latent space most likely to exhibit significant statistical regularities in common with the predicted triple. This step guarantees that the explanation generated in downstream steps reflects the internal mechanics of the KGE model by localizing the explanation around the instance that the model learned to see and treat similarly. The embeddings are then mapped back to their symbolic triple representations, the relationship symbol is dropped, and the entity pairs are stored in

$$kNN ( {t}_{p} ) = {arg min}_{t ∈ T} {}_{k} {‖ {t}_{p} - t ‖}_{2}$$

Step two involves the construction of positive and negative entity pairs. For each nearest neighbor pair (nᵢ, nⱼ) from the set N, a pair is a member of the positive entity-pairs P⁺ if (nᵢ, rₚ, nᵢ) is an existing fact in G, ensuring that the relationship is consistent with known facts. Conversely, a negative pair (nₖ, nₗ) is a member of P⁻ if (nₖ, rₚ, nₗ) does not exist in G, essentially representing a corrupted version of a positive pair. This is formally expressed as:

$${P}^{+} = \{ ( {n}_{i} , {n}_{j} ) ∈ N \vert ( {n}_{i} , {r}_{p} , {n}_{j} ) ∈ G \}$$

$${P}^{-} = \{ ( {n}_{k} , {n}_{l} ) \vert ( {n}_{k} = {n}_{i} ⊕ {n}_{l} = {n}_{j} ) ∧ ( {n}_{k} , {r}_{p} , {n}_{l} ) ∉ G \} ,$$

$$with ( {n}_{i} , {n}_{j} ) ∈ {P}^{+} ∧ n ∈ E$$

The process results in two sets, P₊ containing pairs connected by the predicted link and have a similar latent representation with the predicted triple, and P₋, which includes pairs that serve as corrupted versions of the positive pairs. One corrupted pair may be sampled for every pair in N. This procedure is similar to the stochastic local closed-world assumption applied while training KGE models.

In the third step, clauses and their frequencies for the entity pairs in P are mined within the neighborhoods of G.

For each pair (e_{head}, eₜₐᵢₗ) in the combined set of positive and negative pairs P={P⁺∪P⁻}, walks w of (1→n)-steps are constructed in G, initiating or terminating at either e_{head} or eₜₐᵢₗ.

Each entity in w transforms a function a: E→C▪{Head, Tail}, which abstracts entities to their respective classes, while assigning e_{head} and eₜₐᵢₗ the class Head and T ail. This abstraction acknowledges the predictive significance of paths that start or finish at the head or tail entities. Each abstracted walk is a clause c.

Additionally, single-step walks initiating or terminating at either e_{head} or eₜₐᵢₗ are constructed, wherein only the head and tail entities are abstracted, enabling the capture of properties related to the head or tail node.

The method thus captures the following clause types:

$${r}_{1} ( x , W ) ∧ {r}_{2} ( X , Y ) ∧ … ∧ {r}_{m} ( Y , y )$$

$${r}_{1} ( x , W ) ∧ {r}_{2} ( X , Y ) ∧ … ∧ {r}_{m} ( Y , Z )$$

$${r}_{1} ( X , Y ) ∧ {r}_{2} ( X , Z ) ∧ … ∧ {r}_{m} ( Z , y )$$

$$r ( x , e ) ,$$

where x, y∈{Head, Tail}, the variable m≤n is the actual step length, and W, X, Y, and W are classes.

For each unique clause thus obtained, its entailment frequency f_{c} within the subgraph neighborhood of an entity-pair is computed. The frequency of a clause quantifies the ratio of its groundings within the subgraph neighborhood to the total groundings of all clauses within the same locality. This provides a relative measure of prevalence for each clause, reflecting its significance in the subgraph neighborhood of an entity-pair.

Each pair's tuple (c, f_{c}) is stored in D (e_{head}, eₜₐᵢₗ). Thus, it stores all unique clauses and their frequencies for every pair. Algorithm 1 details the third step.

Algorithm 1 Mining Clauses and Frequencies in Subgraph
Neighborhoods of Entity Pairs

```
Input: Set of positive pairs P⁺, set of negative pairs P⁻,
knowledge graph G
Parameter: Maximum walk length n
Output: Dictionary D mapping pairs to unique clauses and
their frequencies
  for ∀(ϵ_{head}, ϵₜₐᵢₗ) ∈ P⁺ ∪ P⁻ do
    Initialize an empty list S₍ₑ_{_{head}}, ₑ_{ₜₐᵢₗ}₎ to store clauses
    for each walk w of (l → n)-steps in G starting/ending
    at e_{head} or eₜₐᵢₗ do
      c ← clause obtained by applying a to entities in w
      if length of w = 1 then
        c ← c ∪ w with abstracted head and tail entity
      end if
      Append c to S₍ₑ_{_{head}}, ₑ_{ₜₐᵢₗ}₎
    end for
    for each unique clause c in S₍ₑ_{_{head}}, ₑ_{ₜₐᵢₗ}₎ do
    ${f}_{c} ← \frac{\vert ( c ∈ {S}_{( {e}_{head} , {e}_{tail} )} ) \vert}{\vert {S}_{( {e}_{head} , {e}_{tail} )} \vert}$
    Store (c, f_{c} ) in D₍ₑ_{_{head}}, ₑ_{ₜₐᵢₗ})
  end for
end for
```

This process ensures that the frequency landscape of clauses is mapped, which will be used in the following step for identifying the statistical regularities in the form of clauses the KGE model uses for prediction.

Dataset D establishes a classic tabular machine learning setup, wherein instances are represented by entity pairs, features by clauses, and values by the frequency of the clauses. The labels are categorized as positive or negative based on the entity pair's P+ or P−membership. The objective is to identify which feature (clause) contributes the most to classifying an entity pair as positive. This is achieved by utilizing surrogate models, which extract the features important to interpret the complex relationships within the data.

Thus, the goal is to assign each clause a score by which it is ranked according to its relevance for classifying an entity pair as positive or negative. Some methods for identifying the importance of features include the mean decrease in impurity, K-Lasso, and HSIC-Lasso.

The mean decrease in impurity (MDI) quantifies each clause's role in classifying positive or negative samples in D through an ensemble of decision trees. This process entails iterative data splitting based on clauses that maximize impurity reduction, employing the Gini impurity as a measure of this reduction. The Gini impurity for a dataset d∈D is defined as:

$$Gini ( d ) = 1 - {\sum }_{i} {p ( i \vert t )}^{2}$$

where p(i|t) denotes the proportion of class i∈{positive, negative} at node d⊆D, adjusted by weights α reflecting the L² distance of the pair embedding t to the predicted pairs' embedding tₚ. The weight is defined as an exponential kernel α(t)=exp(−(L²(tₚ,t)²/σ²) with kernel width σ. This assigns a higher impact to pairs that the model perceives as similar. The Gini impurity evaluates the likelihood of mislabeling an element if randomly assigned based on the subset's label distribution, serving as a statistical regularity indicator in D. Most relevant features reduce the Gini impurity of a dataset by the most overall nodes within the tree.

The impurity reduction (ΔGini) from splitting at node d on clause c, yielding “positive” (L) and “negative” (R) child nodes, is given by:

$$Δ Gini ( d , c ) = Gini ( d ) - ( \frac{{N}_{L}}{{N}_{d}} Gini ( L ) + \frac{{N}_{R}}{{N}_{d}} Gini ( R ) )$$

Here, N_{d}, N_{L}, and N_{R} represent the weighted counts of samples at the parent node and each child node, respectively.

The MDI for a clause across the ensemble is the impurity reductions' mean, weighted by the samples reaching the nodes where the feature splits the data:

$$MDI ( c ) = 1 - \frac{{α}_{c}}{N} {\sum }_{{d}_{c} ∈ D} Δ Gini ( {d}_{f} , c ) {N}_{d}$$

where d_{c} is a node split on clause c, and N_{d} is the total sample count in d_{c}. A weighted frequency co-factor γ is then added to the MDI of a clause. It is defined as:

$$γ ( c ) = \{ \begin{matrix}1 & if {\sum }_{f ∈ {D}_{+}} fw \geq {\sum }_{f ∈ {D}_{-}} fw \\ - 1 & otherwise\end{matrix}$$

This allows weighing whether a clause is more frequent in positive pairs or negative pairs.

MDI thereby assesses clause importance, identifying those crucial for positive pair classifications within D, revealing key statistical patterns in similar sub-graph neighborhoods. Nonetheless, MDI may favor features with higher cardinality, such as those capturing multi-hop regularities, over binary property relations due to inherent biases toward features with a broader variation.

The K-Lasso method uses a linear model, specifically ridge regression, to weight each clause contribution in the classification task within dataset D. The method learns a weight for every feature (clause), employing linear least squares with L² regularization to optimize the model. The objective function minimized by this model is formalized as:

$$min ( {\sum }_{( {e}_{i} , {e}_{j} ) ∈ D} {α}_{( {e}_{i} , {e}_{j} )} ( {y}_{( {e}_{i} , {e}_{j} )} - {C}_{( {e}_{i} , {e}_{j} )}^{T} w ) + β {‖ w ‖}_{2}^{2} )$$

Here, N is the number of instances, y∈−1, 1 is the label for the entity pair (eᵢ, eⱼ)∈D, C is the feature vector holding the frequencies of all clauses of an entity pair, and w is the vector of weights corresponding to the clauses. The kernel α(t)=exp(−(L²(tₚ,t)²/σ²) with kernel width σ scales the impact of pairs that the model perceives as similar, allowing for differential emphasis on instances based on their respective weights. The term is the weighted sum of squared residuals, where each residual's contribution is adjusted by the distance-specific weight α(eᵢ, eⱼ). The parameter β is for the L² regularization, penalizing the sum of squared weights to prevent overfitting. After fitting the surrogate model, the learned weights w for each feature directly measure feature importance. These weights reflect the contribution of each clause to the prediction task, with larger absolute values indicating greater importance. This may enable the identification of the most relevant clauses that contribute to classifying entity pairs as positive or negative, providing insights the underlying statistical regularities captured by the KGE models.

Compared to MDI, K-Lasso is not biased towards features with high cardinality. However, it permits only linear feature selection, which may not effectively capture complex relationships in certain datasets.

The Hilbert-Schmidt Independence Criterion Lasso (HSIC Lasso) is a supervised nonlinear feature selection methodology to identify a subset of input features relevant to predicting output values. As an extension of the standard Lasso, HSIC Lasso incorporates a feature-wise kernelized Lasso to capture nonlinear dependencies between inputs and outputs. This may enable it to identify non-redundant with a significant statistical dependence on the output values.

The optimization problem of HSIC Lasso is formalized as follows:

$${min}_{{w}_{1} , … , {w}_{d}} \frac{1}{2} {‖ L - {\sum }_{k} {w}_{k} {\tilde{K}}^{( k )} ‖}_{F}^{2} + λ {\sum }_{k} \vert {w}_{k} \vert ,$$

$$with {w}_{1} , … , {w}_{d} \geq 0$$

where |·|F denotes the Frobenius norm, \tilde{K}^{(k)} represents the centered Gram matrix for the k-th feature, and L is the centered Gram matrix for the output y.

After training the surrogate model, coefficients (w) are obtained, which, when multiplied by the frequency co-factor γ, identify clauses predominantly associated with the sub-graph neighborhood of positive entity pairs. The coefficients reflect how relevant each clause is to the prediction.

Method 100 may output explanation data. Explanation data may comprise a rule-based explanation, wherein the rule-based explanation is generated by appending an implication to each clause, an instance-based explanation, wherein the instance-based explanation is generated by grounding literals of each clause in the knowledge graph, and an analogy-based explanation, wherein the analogy-based explanation is generated by grounding the literals of each clause in with a nearest pair of the plurality of positive concept pairs.

After obtaining the most descriptive clauses from the surrogate model, they are used to generate explanations of the KGE model. The approach allows the generation of three explanation types, each catering to distinct aspects of user needs: rule-based, instance-based, and analogy-based (see Table 1).

Rule-based explanations are derived by appending an implication to the identified clauses, thus forming a set of symbolic rules. These rules express the implicit statistical regularities the model has learned to predict a missing link. For instance, if the most descriptive clause extracted for the predicted triple (Alice, knows, Bob) is knows(Head, Y) ∧works_with(Y, T ail) for the predicted link (Head, knows, T ail), the rule is formulated as knows(Head, Y) ∧works_with(Y, T ail)→knows Alice, Bob). This implies that if for this specific prediction, the conditions specified by the clauses are met, the triple (Alice, knows, Bob) is predicted.

Instance-based explanations are generated by grounding the literals in the knowledge graph. In logical terms, Grounding means replacing the variables in a clause with specific constants from the domain, thus instantiating the clause. For example, if knows(Head, Y) A works_with(Y, Tail) is a clause, and the predicted triple is (Alice, knows, Bob), the grounding would know (Alice, Tom) ∧works_with(Tom, Bob). This explanation provides the concrete triples that led the model to predict the knows-relationship between Alice and Bob.

Analogy-based explanations focus on how the model behaves in similar situations by grounding the literals with the head and tail of the pair from P⁺ that is closest in terms of L² distance to the predicted pair. This approach demonstrates the model's behavior in similar instances, for which the prediction is confirmed to be true. For example, if the nearest pair to (Alice, Bob) in P⁺ is (Carol, Dave), and knows(Head, Y) ∧works_with(Y, Tail) is a clause, the grounding might be knows(Carol, Anja) ∧works_with(Anja, Dave). This shows an analogous situation where the model applied similar reasoning.

Table 1 compares explanation types generated from descriptive clauses, given the predicted triple (Alice, knows, Bob) and its closest positive neighbor (Carol, Dave) as an example.

TABLE 1

| | 1st Clause | 2nd Clause | . . . |
|---|---|---|---|
| Clause | knows(Head, Y) | knows(Head, Y) | . . . |
| | ∧ works | ∧ sibling | |
| | with(Y, Tail) | of(Y, Tail) | |
| Relevance | 0.54 | 0.31 | . . . |
| Rule-Based | knows(Head, Y) | knows(Head, Y) | . . . |
| Explanation | ∧ works with(Y, Tail) | ∧ sibling of(Y, Tail) | |
| | → knows(Alice, Bob) | → knows(Alice, Bob) | |
| Instance-Based | knows(Alice, Tom) | knows(Alice, Pedro) | . . . |
| Explanation | ∧ works with(Tom, | ∧ sibling | |
| | Bob) | of(Pedro, Bob) | |
| Analogy-Based | knows(Carol, Anja) | knows(Carol, Jan) | . . . |
| Explanation | ∧ works_with(Anja, | ∧ sibling | |
| | Dave) | of(Jan, Dave) | |

The resultant triples are then presented to the user in step 140. This allows the user to uncover the hidden statistical regularities the model has learned and utilized to predict the missing link. Such explanations not only enhance the transparency of the model but also increase the user's trust by making the model's predictions understandable and verifiable.

Method 100 may further comprise building 110, the knowledge graph based on a plurality of quadruples. Each quadruple comprises one fact triple of the plurality of triples and a publication date obtained from the source associated with the one fact triple. Method 100 aims to sequence temporarily evolving knowledge graphs and build machine learning architectures to predict triples. This prediction aims to find two unlinked concepts and determine if there is a relationship and what type of relationship it is. The method, for instance, predicts that two chemicals have a relationship and the relationship is a catalyst or, for example, that this pharmaceutical molecule has a relationship to that protein and the relationship is bound to something similar.

Quadruples may be extracted from a plurality of scientific publications. Classically, scientists create hypotheses by reading scientific publications and, eventually, spot patterns or connect loose pieces. This is known as literature-based discovery. Often, discoveries happen by chance when a scientist reads a concept that, enriched with their knowledge, lets them hypothesize a connection. However, modern scientific publishing produces too much output for any scientist to stay on top of it. New publications are produced every day or every week, and no single scientist can keep up with the field they operate in.

However, large databases may cover all scientific publications in, for example, the biomedical field of the last 70 years. These may have a full-text publication in a PDF or other digital format. A KG of fact triples can be constructed by taking these full-text formats and extracting the concept-concept-relationship triple.

For instance, if a sentence in one of these papers says chemical A is a catalyst for chemical B, a triple can be extracted in the format (Chemical A, catalyst, Chemical B) or (Gene, causes, Disease).

In addition, these publications have a publication date. So triples can be enriched with a temporal timestamp. This timestamp may make a quadruple useful in building the KG. A quadruple could be, for example (Chemical A, catalyst, Chemical B, January 1970). In the context of hypothesis generation, where the goal is to predict novel relationships between entities extracted from scientific publications, comprehending prior relationships is of paramount importance. For instance, in the domain of social networks, the principles of social theory come into play when assessing the dynamics of connections between individuals. When there is a gradual reduction in the social distance between two distinct individuals, as evidenced by factors such as the establishment of new connections with shared acquaintances and increased geographic proximity, there emerges a heightened likelihood of a subsequent connection between these two individuals. This concept extends beyond social networks and finds relevance in predicting scientific relationships or events through the utilization of temporal information. In both contexts, the principles of proximity and evolving relationships serve as valuable indicators, enabling a deeper understanding of the intricate dynamics governing these complex systems.

These quadruples can be used to iteratively build a KG using 250 million quadruples or more. In a KG, concepts are always nodes and edges are always relationships. Then you have the timestamp which tells you when that relationship connecting these two nodes has been discovered.

Using a timestamp allows for the evolution of the graph to be determined. The graph may be grown iteratively to build a KG featuring quadruples published on or before 1970. Then it could be grown with quadruples on or before 1980, so KG is grown over time.

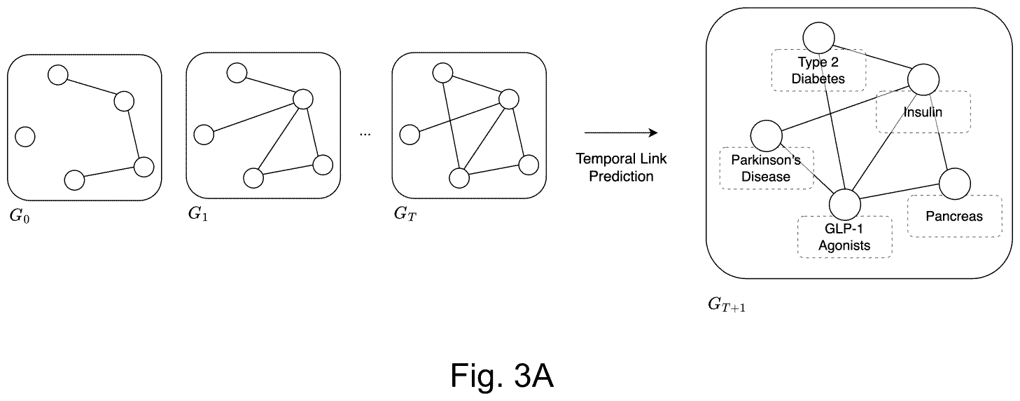

FIGS. 3A and 3B show approaches for building a knowledge graph. FIG. 3A shows a flowchart 300 for building a knowledge graph over time. Specifically, given a sequence of graphs G={G₁, G₂, . . . , G_{T}}, the objective is to deduce which previously unlinked nodes in GT ought to be connected. Taking this sequence of graphs and using hierarchical transformer architectures tries to predict which concepts should be connected additionally which currently do not have an edge in the graph. By knowing how a KG evolved, more predictive efforts can be made in growing areas rather than by making connections in areas that have not seen development. In the former case, a machine-learning algorithm may find better success predicting chemicals, which are likely catalysts of each other but no one in science has yet written about. In the latter case, a machine-learning algorithm may fail trying to make connections in areas where no connections could be made. FIG. 3 shows a temporal graph G, growing from time G₀ to G₁ and to present time G_{T}. Then, using temporal link prediction, a new link between Parkinson's Disease and GLP-1 Agonists can be predicted based on the existing links and the temporal information. A temporal graphlet Gτ={Vτ, Eτ} is a temporal subgraph at time point τ, where Vτ⊂V and Eτ⊂E are the temporal set of nodes and edges of the subgraph. This approach tackles the hypothesis generation problem by introducing a temporal perspective. Instead of relying solely on the final state E_{T} on a static graph, it considers how node pairs evolve over discrete time steps E^{τ}: τ=1 . . . T.

FIG. 3B shows a hierarchical approach 310 building a knowledge graph. Temporal graphs can be built using recurrent neural networks. A robust transformer-based model, such as a Temporal Hierarchical Graph-based Encoder Representation (THiGER) may another of various models that may be used to capture the evolving relationships between node pairs. A THiGER represents temporal relationships hierarchically. The proposed hierarchical layer-wise framework presents an incremental approach to comprehensively model the temporal dynamics among given concepts. It achieves this by progressively extracting the temporal interactions between consecutive time steps, thus enabling the model to prioritize attention to the informative regions of temporal evolution during the process. The pending disclosure may address issues arising from imbalanced temporal information. It may employs a contrastive learning strategy to improve the quality of task-specific node embeddings for node-pair representations and relationship inference tasks.

Method 100 may further comprise sourcing one or more explanations for the hypothesis. Sourcing the one or more explanations may comprise determining a set of the plurality of fact triples within the sub-graph neighborhood based on the one or more explanations and obtaining the source associated with each fact triple.

Once a hypothesis is chosen, a researcher may desire to find the sources that support the hypothesis. This process is critical in ensuring the hypothesis is credible and grounded in established knowledge. By tracing the origins of the data used in formulating the hypothesis, researchers can validate the findings and build upon existing scientific literature. For example, if a hypothesis suggests a new relationship between a specific gene and a disease, the researcher may want to review the original studies that reported the gene-disease associations. This allows for a thorough understanding and verification of the hypothesis.

Sourcing the hypothesis may further comprise providing a link to the source of each fact triple used in one or more explanations. This may narrow the gap between hypothesis generation and data validation, offering a seamless way for researchers to access supporting information. By linking to the sources, the system not only enhances transparency but also may save researchers considerable time and effort in manually locating the original publications. For instance, if the hypothesis is based on multiple gene interaction studies, the system would provide direct links to these studies, allowing researchers to quickly review and assess the validity of the data.

The link may enable navigation to a publication and/or database entry that corresponds to the source. This may ensure that researchers can easily access the detailed context and methodologies of the studies that contributed to the hypothesis. It is particularly useful in fields like bioinformatics or drug discovery, where hypotheses are often based on complex datasets and require thorough vetting. For example, a researcher investigating a potential drug target could use the links provided to access detailed experimental procedures and results from related studies, thereby gaining deeper insights and identifying potential pitfalls to the hypotheses. Or discover areas for further investigation.

The source for each of the fact triples may be a scientific publication. By limiting KGs to scientific publications, the data used in hypothesis generation may be deemed dependable and accurate. Scientific publications are typically peer-reviewed, ensuring a certain level of quality and credibility. By basing the hypotheses on such sources, the system ensures that the generated hypotheses are supported by verified and high-quality data. For example, a hypothesis about the impact of a specific diet on heart disease could be supported by multiple peer-reviewed studies from reputable journals, providing a robust foundation for further research and clinical trials.

Traditional hypothesis generation systems often produce hypotheses without a clear and direct path to the supporting data, leaving researchers to manually verify and locate sources. The embodiments in the present disclosure, by contrast, embed sourcing directly into the workflow, allowing for immediate validation and deeper engagement with the supporting literature. This seamless integration reduces the risk of mistakes, ensures hypotheses are grounded in verified data, and accelerates the research process by providing direct access to relevant studies.

For example, in biomedical research, a hypothesis might suggest a correlation between a specific genetic mutation and an increased risk of Alzheimer's disease. The system may provide links to several peer-reviewed studies that have reported on the genetic mutation's impact on neurological health. Researchers can quickly navigate to these publications to verify the data and understand the context of the findings. In environmental science, a hypothesis could propose that a certain pollutant contributes to the decline of a particular fish species in a specific region. The system may link to environmental studies and governmental reports that have documented the pollutant levels and their ecological impacts. Researchers can access these sources to confirm the hypothesis and design further studies or interventions. In social sciences, a hypothesis may indicate that social media usage positively affects the mental health of teenagers. The system provides direct links to various psychological and sociological studies that have explored the relationship between social media and mental health. This may enable researchers to evaluate the consistency and robustness of the supporting data. By facilitating direct access to the sources, this invention ensures that hypotheses are not only generated efficiently but are also validated and supported by high-quality data, fostering a more rigorous and expedited research process.

Method 100 may further comprise providing the hypothesis 150 to an in-silico experimentation system. The in-silico experimentation system may determine the plausibility of the hypothesis. Once a scientist chooses a hypothesis it must go through a plausibility check. This plausibility check may be automated, and that is then what is called in silico experimentation because it is done on a computer chip. After a hypothesis passes an in-silico plausibility check it may be considered a validated hypothesis and be ready to be evaluated in an actual laboratory. In some scenarios, validated hypotheses may be further provided to automated laboratory equipment for actual lab testing.

The hypothesis may be included in a plurality of hypotheses generated for the predicted triple. Furthermore, the predicted triple may be included in a plurality of predicted triples generated from the knowledge graph.

Method 100 may further comprise allowing a user to search through the plurality of predicted triples, wherein the search is based on a selected concept from the set of concepts and/or a selected relationship from the set of relationships. A search function through the hypothesis space may allow researchers to register interest in a hypothesis, for example, one that has as one of the two concepts' gene ABC or a hypothesis that predicts catalytic relationships.

Method 100 may further comprise displaying a list of a plurality of predicted triples that include the selected concept and/or the selected relationship, along with a summary of the hypothesis for each predicted triple.

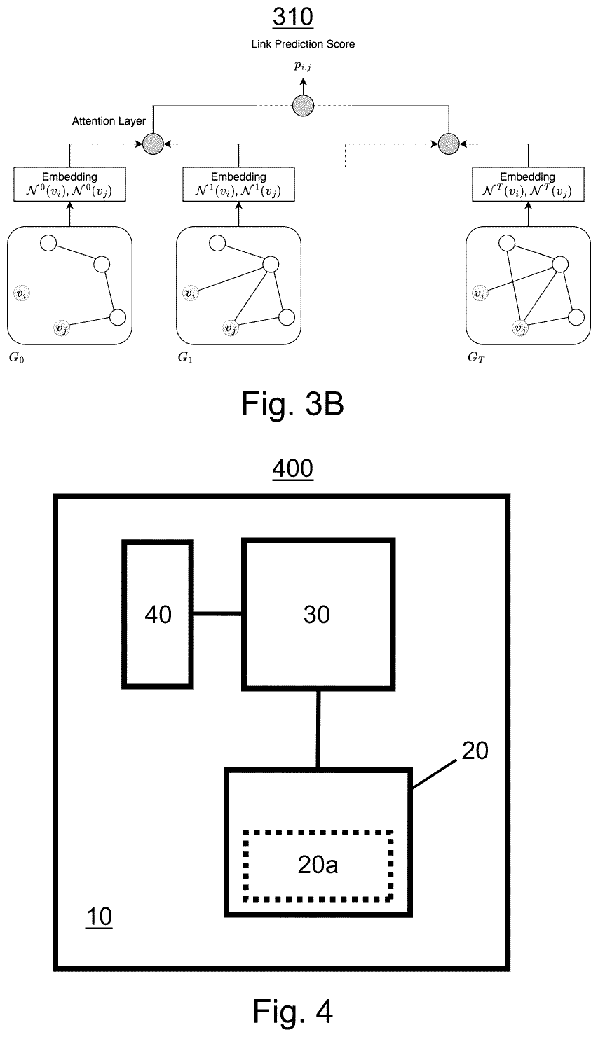

More details and aspects of the concept for offloading a workload may be described in connection with examples discussed below (e.g., FIGS. 4-6).

FIG. 4 shows a block diagram 400 of an example of an apparatus 10 or device 10 for generating a hypothesis comprising control circuitry 30. The control circuitry may be configured to process a knowledge graph comprising a plurality of fact triples, wherein each fact triple of the plurality of fact triples comprises two concepts of a set of concepts and one relationship of a set of relationships, and wherein each fact triple is associated with an at least one source. The control circuitry 30 further configured to generate the hypothesis from data representing multiple triples, the hypothesis including at least one predicted triple having a concept-concept relationship not found in the knowledge graph. The control circuitry 30 then configured to output the at least one source and/or explanation data for the hypothesis.

FIG. 4 further shows interface circuitry 40 to communicate with outside devices or apparatus, memory circuitry 20 and machine-readable instructions 20a. The control circuitry 30 may execute the machine-readable instructions to perform any of the embodiments disclosed herein. The memory circuitry 20 may be a non-transitory, computer-readable medium comprising a program code 20a that, when the program code is executed on a processor, a computer, or a programmable hardware component, causes the processor, computer, or programmable hardware component to perform the embodiments disclosed herein.

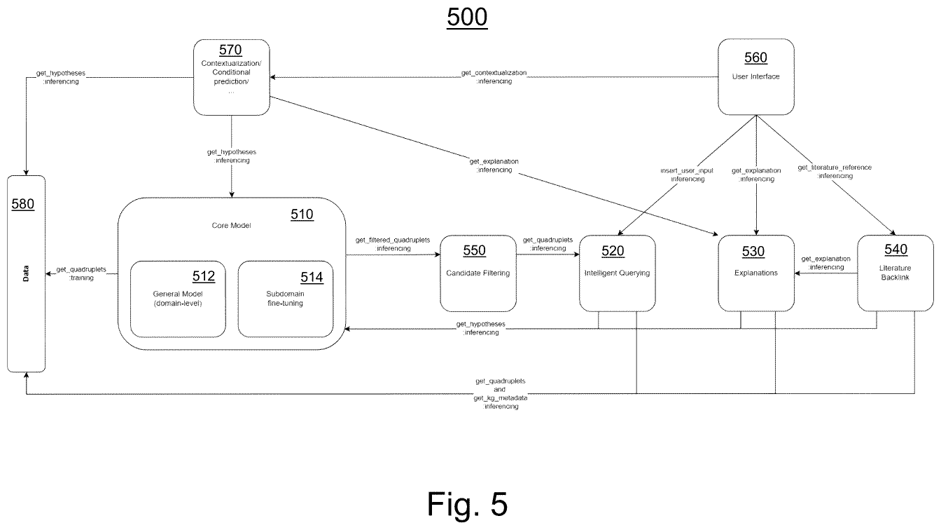

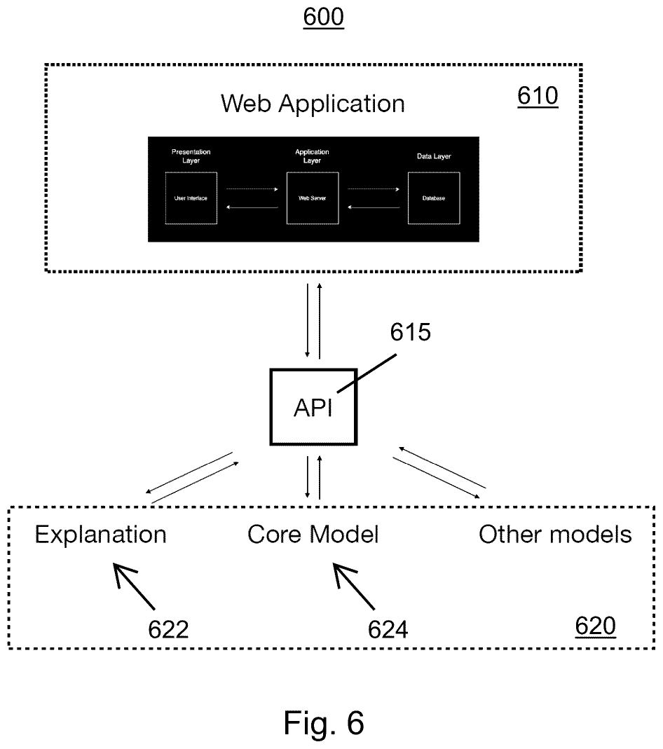

More details and aspects of the concept for offloading a workload may be described in connection with examples discussed above (e.g., FIGS. 1-3B) or below (e.g., FIGS. 5-6).

FIG. 5 shows a block diagram of a system 500 for generating a hypothesis. The system 500 may comprise a core module 510, an intelligent querying module 520, and explanations module 530, a literature backlink module 540, a candidate filtering module 550, a user interface module 560, and a contextualization/conditional prediction module 570. The system may also have a data source 590. The core module 510 may have submodules such as the general module (domain level) 512 and the subdomain fine-tuning module 514. The modules may communicate via various API calls.

The system 500 for generating a hypothesis, as depicted in FIG. 5, consists of various interconnected modules that perform specialized tasks to collectively generate and refine hypotheses from a knowledge graph. These modules can reside on a single system or be distributed across multiple systems, communicating via a network. The communication between modules may be facilitated through API calls, ensuring seamless interaction and data exchange.

The core module 510 may be responsible for the central processing tasks required to generate hypotheses from the knowledge graph. The general module 512 may handle broad domain-level processing, managing general knowledge and relationships within the graph. The subdomain fine-tuning module 514 may focus on specific subdomains, applying fine-tuned algorithms to extract more nuanced and detailed relationships within particular areas of the knowledge graph. The intelligent querying module 520 may enable advanced querying capabilities, allowing users and other system components to query the knowledge graph intelligently. It may support complex queries that can identify potential relationships and generate initial hypotheses. The explanations module 530 may generate explanations for the hypotheses by analyzing the sub-graph neighborhoods and identifying relevant fact triples. It may provide rule-based, instance-based, or analogy-based explanations.

The literature backlink module 540 may link hypotheses and explanations back to their original sources, such as scientific publications, ensuring traceability and credibility of the information. The candidate filtering module 550 may evaluate and filters potential hypotheses based on relevance and validity, using criteria defined by the system or user inputs.

The user interface module 560 may provide a graphical interface for users to interact with the system, search for predicted triples, view hypotheses, and access explanations and sources. The user interface module comprises hardware and software components configured to provide a graphical user interface (GUI) that allows users to interact with the system. It includes a display component, such as a screen or monitor, for showing graphical elements like text, images, buttons, and menus. An input component, such as a keyboard, mouse, or touchscreen, is configured to receive user commands and data inputs. The module also features a communication interface with software APIs and protocols to facilitate data exchange between the user interface and other system modules. Additionally, a rendering engine converts backend data into visual formats for display, and an event handler manages user interactions by interpreting actions such as clicks and typing. Lastly, a data management component ensures accurate data flow between the user interface and backend modules.

The contextualization/conditional prediction module 570 may contextualize the predictions, providing conditional predictions based on current knowledge and trends, and enhancing the relevance and accuracy of the hypotheses.

The system relies on a data source 590, which may include knowledge graphs, databases, and other repositories of fact triples. This data source can be local or remotely accessible via network connections.

The modules within the system 500 can be deployed on a single machine or distributed across multiple systems, connected through a network. This flexibility allows for scalability and efficient resource management. The networked deployment can involve various configurations, such as Local Area Network (LAN), Wide Area Network (WAN), and Cloud-based Deployment.

The modules may communicate via API calls, which standardize the interactions and data exchanges between various parts of the system. These API calls enable data retrieval and updates, task coordination, and user interaction.

The System 500 utilizes various API calls to facilitate efficient communication and data exchange between its modules. For user interactions, the insert_user_input: inferencing API call may allow the user interface module 560 to send user inputs to the intelligent querying module 520, enabling user-driven querying of the knowledge graph. The user interface module 560 may also retrieve explanations and literature references using the get_explanation: inferencing and get_literature_reference: inferencing API calls directed to the explanations module 530 and the literature backlink module 540, respectively.

For hypothesis generation and contextual predictions, the get_hypothesis: inferencing API call may enable the intelligent querying module 520 and the explanations module 530 to communicate with the core module 510, while the get_contextualization: inferencing call may allow the user interface module 560 to interact with the contextualization/conditional prediction module 570. Additionally, the contextualization/conditional prediction module 570 may use the get_explanation:inferencing call to obtain explanations from the explanations module 530, and the get_hypothesis:inferencing calls to interact with both the core module 510 and the data source 590 for contextualized hypotheses.

For data retrieval and management, the literature backlink module 540 may use the get_quadruplets:inferencing and get_kg_metadata:inferencing API calls to gather quadruples and metadata from the data source 590. The candidate filtering module 550 retrieves relevant quadruples through the get_quadruplets:inferencing API call directed to the intelligent querying module 520, and the core module 510 may employ the get_filtered_quadruplets:inferencing call to receive filtered quadruples from the candidate filtering module 550. Additionally, the core module 510 may use the get_quadruplets:training API call to obtain quadruples necessary for training from the data source 590.

These API calls enable a structured and coordinated workflow, ensuring that each module can effectively contribute to the system's overall functionality and user experience. By leveraging a modular design and network communication, the system 500 efficiently generates, refines, and explains hypotheses, ensuring robust and scalable operation across various deployment scenarios.

More details and aspects of the concept for offloading a workload may be described in connection with examples discussed above (e.g., FIGS. 1-4) or below (e.g., FIG. 6).

FIG. 6. shows a block diagram 600 with an end-user terminal for obtaining a hypothesis. The end-user terminal 610 may comprise control circuitry configured to request the hypothesis from a server 620, wherein the server comprises control circuitry configured to generate a hypothesis from a knowledge graph and receive at least one source and/or explanation data for the hypothesis.

The end-user terminal may be a web application connected to the server or a plurality of servers 620 via an application programming interface (API) 615 to connect to the explanation module 622, the core module 624, or other modules

The end-user terminal may provide user data to the server as part of the request, select or provide the knowledge graph to the server, and query the server for information on the hypothesis.

The API may be interfaced with a simple web application where researchers may go and generate hypotheses (e.g., for the biomedical field or to do with gene ABC). The system 600 can generate a hypothesis and present it to the user. The user than can then list the research or publications connected with the hypothesis and then search this list according to the desired criteria. The functionality of hypothesis generation and hypothesis explanation, contextualization, and search through the hypothesis space can be deployed to researchers in a simple web app or to be deployed into existing research databases.

A non-transitory, computer-readable medium comprising a program code that, when the program code is executed on a processor, a computer, or a programmable hardware component, causes the processor, computer, or programmable hardware component to perform any of the methods discussed herein.

More details and aspects of the concept for adapting a processor to a workload may be described in connection with examples discussed above (e.g., FIGS. 1-5).

The aspects and features described in relation to a particular one of the previous examples may also be combined with one or more of the further examples to replace an identical or similar feature of that further example or to additionally introduce the features into the further example.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

An example (e.g., example 1) relates to a method for generating a hypothesis from a knowledge graph, the method comprising: processing the knowledge graph comprising a plurality of fact triples, wherein each fact triple of the plurality of fact triples comprises two concepts of a set of concepts and one relationship of a set of relationships, and wherein each fact triple is associated with at least one source; generating the hypothesis from data representing multiple triples, the hypothesis including at least one predicted triple having a concept-concept relationship not found in the knowledge graph; and outputting the at least one source and/or explanation data for the hypothesis.

Another example (e.g., example 2) relates to the previously described example (e.g., example 1), wherein generating the hypothesis comprises: determining a sub-graph neighborhood of the knowledge graph for the at least one predicted triple; creating a plurality of positive concept pairs and a plurality of negative concept pairs, wherein each positive concept pair represents one fact triple in the sub-graph neighborhood comprising the predicted relationship and each negative concept pair represents one triple comprising the predicted relationship not found within the knowledge graph; extracting a plurality of clauses from a combined set of the plurality of positive concept pairs and the plurality of negative concept pairs; determining a relevance of each clause of the plurality of clauses; and selecting the hypothesis from the plurality of clauses based on the relevance of each clause.

Another example (e.g., example 3) relates to a previously described example (e.g., example 1 or 2), wherein the explanation data comprises at least one of: a rule-based explanation, wherein the rule-based explanation is generated by appending an implication to each clause, an instance-based explanation, wherein the instance-based explanation is generated by grounding literals of each clause in the knowledge graph, and an analogy-based explanation, wherein the analogy-based explanation is generated by grounding the literals of each clause with a nearest pair of the plurality of positive concept pairs.

Another example (e.g., example 4) relates to a previously described example (e.g., one of the examples 1-3), further comprising building the knowledge graph based on a plurality of quadruples, each quadruple comprising one fact triple of the plurality of triples and a publication date obtained from the source associated with the one fact triple.

Another example (e.g., example 5) relates to the previously described example (e.g., example 4), wherein quadruples are extracted from a plurality of scientific publications.

Another example (e.g., example 6) relates to the previously described example (e.g., one of the examples 1-5), wherein the knowledge graph comprises a plurality of nodes connected by a plurality of edges, wherein each node of the plurality of nodes represents one concept of the set of concepts, and each edge is classifiable as one relationship of the set of relationships.

Another example (e.g., example 7) relates to the previously described example (e.g., one of the examples 1-6), further comprising sourcing the one or more explanations for the hypothesis.

Another example (e.g., example 8) relates to the previously described example (e.g., example 7), wherein sourcing the one or more explanations comprises determining a set of the plurality of fact triples within the sub-graph neighborhood based on the one or more explanations and obtaining the source associated with each fact triple.

Another example (e.g., example 9) relates to the previously described example (e.g., example 7 or 8), wherein sourcing the hypothesis comprises providing a link to the source of each fact triple used in the one or more explanations.

Another example (e.g., example 10) relates to the previously described example (e.g., example 9), wherein the link navigates to a publication and/or database entry that corresponds to the source.

Another example (e.g., example 11) relates to the previously described example (e.g., one of the examples 1-10), wherein the source for each of the fact triples is a scientific publication.

Another example (e.g., example 12) relates to the previously described example (e.g., one of the examples 1-11), further comprising providing the hypothesis to an in-silico experimentation system.

Another example (e.g., example 13) relates to the previously described example (e.g., one of the examples 1-12), wherein the in-silico experimentation system determines a plausibility of the hypothesis.

Another example (e.g., example 14) relates to the previously described example (e.g., one of the examples 1-13), wherein the hypothesis is included in a plurality of hypotheses generated for the predicted triple.

Another example (e.g., example 15) relates to the previously described example (e.g., one of the examples 1-14), wherein the predicted triple is included in a plurality of predicted triples generated from the knowledge graph.

Another example (e.g., example 16) relates to the previously described example (e.g., example 15), further comprising generating a user interface configured to allow a search through the plurality of predicted triples, wherein the search is based on a selected concept from the set of concepts and/or a selected relationship from the set of relationships.

Another example (e.g., example 17) relates to the previously described example (e.g., example 16), wherein the user interface displays a list of the plurality of predicted triples that include the selected concept and/or the selected relationship, along with a summary of the hypothesis for each predicted triple.

Another example (e.g., example 18) relates to the previously described example (e.g., one of the examples 1-17), wherein generating the predicted triple further comprises receiving a user input, wherein the user input selects at least one of the first concept, the second concept, or the predicted relationship.

Another example (e.g., example 19) relates to the previously described example (e.g., one of the examples 1-18), further comprising receiving user input data, wherein the user input selects at least one of the first concept, the second concept, or the predicted relationship.

An example (example 20) relates to a non-transitory, computer-readable medium comprising program code that, when the program code is executed on a processor, a computer, or a programmable hardware component, causes the processor, computer, or programmable hardware component to perform the method of a previously described example (e.g., one of the examples 1-19).

An example (example 21) relates to an apparatus for generating a hypothesis comprising control circuitry configured to: process a knowledge graph comprising a plurality of fact triples, wherein each fact triple of the plurality of fact triples comprises two concepts of a set of concepts and one relationship of a set of relationships, and wherein each fact triple is associated with at least one source; generate the hypothesis from data representing multiple triples, the hypothesis including at least one predicted triple having a concept-concept relationship not found in the knowledge graph; and output the at least one source and/or explanation data for the hypothesis.

Another example (e.g., example 22) relates to the previously described example (e.g., example 21), wherein the control circuitry is further configured to: determine a sub-graph neighborhood of the knowledge graph for the at least one predicted triple; create a plurality of positive concept pairs and a plurality of negative concept pairs, wherein each positive concept pair represents one fact triple in the sub-graph neighborhood comprising the predicted relationship and each negative concept pair represents one triple comprising the predicted relationship not found within the knowledge graph; extract a plurality of clauses from a combined set of the plurality of positive concept pairs and the plurality of negative concept pairs; determine a relevance of each clause of the plurality of clauses; and selecting the hypothesis from the plurality of clauses based on the relevance of each clause.

Another example (e.g., example 23) relates to a previously described example (e.g., example 21 or 22), wherein the explanation data comprises at least one of: a rule-based explanation, wherein the rule-based explanation is generated by appending an implication to each clause, an instance-based explanation, wherein the instance-based explanation is generated by grounding literals of each clause in the knowledge graph, and an analogy-based explanation, wherein the analogy-based explanation is generated by grounding the literals of each clause with a nearest pair of the plurality of positive concept pairs.

Another example (e.g., example 24) relates to a previously described example (e.g., one of the examples 21-23), further comprising building the knowledge graph based on a plurality of quadruples, each quadruple comprising one fact triple of the plurality of triples and a publication date obtained from the source associated with the one fact triple.

Another example (e.g., example 25) relates to the previously described example (e.g., example 24), wherein quadruples are extracted from a plurality of scientific publications.

Another example (e.g., example 26) relates to the previously described example (e.g., one of the examples 21-25), wherein the knowledge graph comprises a plurality of nodes connected by a plurality of edges, wherein each node of the plurality of nodes represents one concept of the set of concepts, and each edge is classifiable as one relationship of the set of relationships.

Another example (e.g., example 27) relates to the previously described example (e.g., one of the examples 21-26), wherein the control circuitry is further configured to source the one or more explanations for the hypothesis.

Another example (e.g., example 28) relates to the previously described example (e.g., example 27), wherein sourcing the one or more explanations comprises determining a set of the plurality of fact triples within the sub-graph neighborhood based on the one or more explanations and obtaining the source associated with each fact triple.

Another example (e.g., example 29) relates to the previously described example (e.g., example 25 or 28), wherein sourcing the hypothesis comprises providing a link to the source of each fact triple used in the one or more explanations.

Another example (e.g., example 30) relates to the previously described example (e.g., example 29), wherein the link navigates to a publication and/or database entry that corresponds to the source.

Another example (e.g., example 31) relates to the previously described example (e.g., one of the examples 21-30), wherein the source for each of the fact triples is a scientific publication.

Another example (e.g., example 32) relates to the previously described example (e.g., one of the examples 21-32), wherein the control circuitry is further configured to provide the hypothesis to an in-silico experimentation system.

Another example (e.g., example 33) relates to the previously described example (e.g., one of the examples 21-32), wherein the in-silico experimentation system determines a plausibility of the hypothesis.

Another example (e.g., example 34) relates to the previously described example (e.g., one of the examples 21-33), wherein the hypothesis is included in a plurality of hypotheses generated for the predicted triple.

Another example (e.g., example 35) relates to the previously described example (e.g., one of the examples 21-34), wherein the predicted triple is included in a plurality of predicted triples generated from the knowledge graph.

Another example (e.g., example 36) relates to the previously described example (e.g., example 25), wherein the control circuitry is further configured to generate a user interface configured to allow a search through the plurality of predicted triples, wherein the search is based on a selected concept from the set of concepts and/or a selected relationship from the set of relationships.

Another example (e.g., example 37) relates to the previously described example (e.g., example 36), wherein the user interface displays a list of the plurality of predicted triples that include the selected concept and/or the selected relationship, along with a summary of the hypothesis for each predicted triple.

Another example (e.g., example 38) relates to the previously described example (e.g., one of the examples 21-37), wherein generating the predicted triple further comprises receiving a user input, wherein the user input selects at least one of the first concept, the second concept, or the predicted relationship.

Another example (e.g., example 39) relates to the previously described example (e.g., one of the examples 21-28), wherein the control circuitry is further configured to receive user input data, wherein the user input selects at least one of the first concept, the second concept, or the predicted relationship.

An example (example 40) relates to an apparatus for obtaining a hypothesis comprising control circuitry configured to request the hypothesis from an apparatus for generating a hypothesis, wherein the server comprises control circuitry configured to generate a hypothesis from a knowledge graph; and receive an at least one source and/or explanation data for the hypothesis.

Another example (e.g., example 41) relates to the previously described example (e.g., example 40), wherein the apparatus is server hosting a web application connected to the apparatus for generating a hypothesis via an application programming interface.

Another example (e.g., example 42) relates to the previously described example (e.g., one of the examples 40-41), wherein the application programming interface connects to an explanation module, a core module, and/or another module.

Another example (e.g., example 43) relates to the previously described example (e.g., one of the examples 40-42), wherein the apparatus provides user data to the apparatus for generating a hypothesis as part of the request and/or selects or provide the knowledge graph to the apparatus for generating a hypothesis and/or queries the apparatus for generating a hypothesis r for information on the hypothesis,

An example (e.g., example 44) relates to a system comprising a server apparatus according to a previously described example (e.g., one of the examples 21-39) and an end-user apparatus according to a previously described example (e.g., one of the examples 40-43).)

The aspects and features described in relation to a particular one of the previous examples may also be combined with one or more of the further examples to replace an identical or similar feature of that further example or to additionally introduce the features into the further example.

Examples may further be or relate to a (computer) program, including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor-or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps,-functions,-processes, or-operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product (e.g., machine-readable instructions, program code, etc.). Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although, in the claims, a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. A method for generating a hypothesis from a knowledge graph:
processing the knowledge graph comprising a plurality of fact triples, wherein each fact triple of the plurality of fact triples comprises two concepts of a set of concepts and one relationship of a set of relationships, and wherein each fact triple is associated with at least one source;
generating the hypothesis from data representing multiple triples, the hypothesis including at least one predicted triple having a concept-concept relationship not found in the knowledge graph; and
output at least one source and/or explanation data for the hypothesis.

2. The method of claim 1, wherein generating the hypothesis comprises,
determining a sub-graph neighborhood of the knowledge graph for the at least one predicted triple;
creating a plurality of positive concept pairs and a plurality of negative concept pairs,
wherein each positive concept pair represents one fact triple in the sub-graph neighborhood comprising the predicted relationship and each negative concept pair represents one triple comprising the predicted relationship not found within the knowledge graph;
extracting a plurality of clauses from a combined set of the plurality of positive concept pairs and the plurality of negative concept pairs;
determining a relevance of each clause of the plurality of clauses; and
selecting the hypothesis from the plurality of clauses based on the relevance of each clause.

3. The method of claim 1, wherein the explanation data comprises at least one of:
a rule-based explanation, wherein the rule-based explanation is generated by appending an implication to each clause,
an instance-based explanation, wherein the instance-based explanation is generated by grounding literals of each clause in the knowledge graph, and
an analogy-based explanation, wherein the analogy-based explanation is generated by grounding the literals of each clause in with a nearest pair of the plurality of positive concept pairs.

4. The method of claim 1, further comprising building the knowledge graph based on a plurality of quadruples, each quadruple comprising one fact triple of the plurality of triples and a publication date obtained from the source associated with the one fact triple.

5. The method of claim 4, wherein quadruples are extracted from a plurality of scientific publications.

6. The method of claim 1, wherein the knowledge graph comprises a plurality of nodes connected by a plurality of edges, wherein each node of the plurality of nodes represents one concept of the set of concepts, and each edge is classifiable as one relationship of the set of relationships.

7. The method of claim 1, further comprising sourcing the one or more explanations for the hypothesis.

8. The method of claim 7, wherein sourcing the one or more explanations comprises determining a set of the plurality of fact triples within the sub-graph neighborhood based on the one or more explanations and obtaining the source associated with each fact triple.

9. The method of claim 7, wherein sourcing the hypothesis comprises providing a link to the source of each fact triple used in the one or more explanations.

10. The method of claim 9, wherein the link navigates to a publication and/or database entry that corresponds to the source.

11. The method of claim 1, wherein the source for each of the fact triples is a scientific publication.

12. The method of claim 1, further comprising providing the hypothesis to an in-silico experimentation system.

13. The method of claim 12, wherein the in-silico experimentation system determines a plausibility of the hypothesis.

14. The method of claim 1, wherein the hypothesis is included in a plurality of hypotheses generated for the predicted triple.

15. The method of claim 1, wherein the predicted triple is included in a plurality of predicted triples generated from the knowledge graph.

16. The method of claim 15, further comprising:
generating a user interface configured to allow a search through the plurality of predicted triples, wherein the search is based on a selected concept from the set of concepts and/or a selected relationship from the set of relationships.

17. The method of claim 16,
wherein the user interface displays a list of plurality of predicted triples that include the selected concept and/or the selected relationship, along with a summary of the hypothesis for each predicted triple.

18. The method of claim 1,
wherein generating the predicted triple further comprises receiving a user input, wherein the user input selects at least one of the first concept, the second concept, or the predicted relationship.

19. A non-transitory, computer-readable medium comprising a program code that, when the program code is executed on a processor, a computer, or a programmable hardware component, causes the processor, computer, or programmable hardware component to perform the method of claim 1.

20. An apparatus for generating a hypothesis comprising control circuitry configured to:
process a knowledge graph comprising a plurality of fact triples, wherein each fact triple of the plurality of fact triples comprises two concepts of a set of concepts and one relationship of a set of relationships, and wherein each fact triple is associated with at least one source;
generate the hypothesis from data representing multiple triples, the hypothesis including at least one predicted triple having a concept-concept relationship not found in the knowledge graph; and
output at least one source and/or explanation data for the hypothesis.
